(19) United States
(12) Patent Application Publication
(10) Pub. No.: US 2026/0141770 A1
(43) Pub. Date: May 21, 2026

(54) PULL-TAB SIMULATOR AND GAME

(71) Applicant: Arrow International, Inc., Brooklyn, OH (US)

(72) Inventors: Andrew Mitchell, Las Vegas, NV (US); Marvel Renee Johnson, Las Vegas, NV (US)

(73) Assignee: Arrow International, Inc., Brooklyn, OH (US)

(21) Appl. No.: 19/394,478

(22) Filed: Nov. 19, 2025

Related U.S. Application Data
(60) Provisional application No. 63/722,208, filed on Nov. 19, 2024.

(51) Int. Cl. G07F 17/32

(52) U.S. Cl. CPC G07F 17/3213; G07F 17/323; G07F 17/3244; G07F 17/329

(57) ABSTRACT

A system and method for simulating paper tickets, such as pull-tab games, in a digital environment are disclosed. The system includes a central server that stores game outcomes, manages digital ticket distribution, and tracks redemptions. A network of client devices, each with a display and input module, communicates with the server to present digital pull-tab tickets and receive user interactions. The game management module in the server stores a finite deal comprising preassigned ticket outcomes, assigns them to digital tickets, and monitors distribution. The system replicates the experience of physical pull-tab games by allowing users to reveal symbols and win awards. A security module authenticates client devices to ensure secure data transmission.

### BACKGROUND

The present invention relates generally to digital gaming systems, and more particularly to a system and method for simulating wagering games featuring paper tickets in a digital environment.

Paper tickets, such as traditional pull-tab games, also called pop opens, break opens, jar tickets, and other names, are a popular form of low stakes gambling typically found in licensed charitable gaming environments such as bingo halls, fraternal organizations and regulated gaming venues. A typical pull-tab game involves multi-layered paper tickets containing hidden symbols, which are revealed by tearing open perforated tabs. Players purchase these tickets and pull back the tabs to reveal combinations of symbols that determine the outcome, as indicated by a pre-defined paytable. The allure of paper pull-tab games lies in their simplicity, instant result delivery, and the excitement of tearing open perforated tabs to uncover a potential win.

A defining aspect of the pull-tab experience is the manual act of pulling or “breaking open” the perforated tabs. Players open the tabs using their fingers, usually by gripping and peeling back a designated perforation to reveal hidden symbols or numbers printed beneath. The tactile action creates anticipation, similar to scratching a scratch of lottery ticket, but with a cleaner more mechanical reveal. The reveal also gives players a sense of agency: they determine the speed and sequence in which they open the tabs, which contributes to the suspense and entertainment value.

While these physical (paper) pull-tab games have been a staple in the gaming industry for decades, they are constrained by several limitations inherent to their physical nature. One major limitation is the requirement for physical production, distribution, and storage of paper tickets. This not only incurs significant costs but also complicates inventory management and compliance with regulatory standards. Additionally, the need for manual intervention in verifying and redeeming winning tickets increases the risk of human error and fraud, thereby reducing operational efficiency.

Electronic pull-tab systems have been introduced in various gaming environments as a way to automate gameplay, reduce manual ticket handling, and streamline accounting. However, despite these operational advances, current electronic pull-tab implementations fail to recreate the distinctive player experience associated with the traditional pull tabs. This experience remains central to player engagement, trust, and entertainment value. Existing electronic pull-tab systems typically offer a basic replication of the paper experience, lacking the immersive and engaging features of the actual perforated paper pull tabs.

From a player's perspective, paper pull-tabs offer several sensory elements that current electronic versions cannot adequately simulate: (i) Lack of Tactile Interaction: Traditional paper pull-tabs require players to physically grip and peel perforated tabs to reveal hidden symbols. This tactile, mechanical action creates anticipation and mimics the reveal-based excitement of uncovering concealed information. Existing electronic systems reduce the reveal to tapping a button or selecting a digital option, eliminating the physical engagement central to paper gameplay; (ii) Absence of Action of Opening: With paper tabs, players personally determine the manner of opening each tab. This contributes to a feeling of agency and suspense. Electronic systems typically reveal them through pre-programmed animations, which lack the variable pacing and personal control inherent in manual tab-opening; and (iii) Diminished Social Experience: In communal environments such as charitable gaming venues, players frequently open paper tickets together, compare symbols, and engage in social commentary. Current electronic pull-tab systems isolate the experience behind a screen, weakening the communal and shared-reaction aspects valued by players.

There is thus a need for an innovative digital simulator platform that not only replicates the tactile and visual experience of traditional paper pull-tab games but also introduces advanced features such as real-time tracking, enhanced security, and automated management of game parameters. Such a platform would offer a scalable and flexible solution for operators, while maintaining the simplicity and excitement that players enjoy in the physical version.

### BRIEF SUMMARY

The present invention addresses the aforementioned limitations by providing a digital pull-tab simulator game system that mimics the physical experience of pull-tab games through a highly interactive and visually engaging digital interface. The system is designed to facilitate the seamless management of game outcomes, player interactions, and regulatory compliance, while enhancing the overall player experience with innovative features such as dynamic animation, sound effects, and integrated win tracking. This digital platform aims to modernize the traditional pull-tab game, making it more accessible, secure, and entertaining for both operators and players.

In one embodiment, a system for digitally simulating a paper pull-tab game is disclosed. Although the exemplary system is described in connection with pull-tab tickets, it is to be understood that the exemplary system is suitable with any form of paper ticket associated with wagering games. The system for digitally simulating a paper pull-tab game includes a central server including at least one processor and memory storing a finite deal comprising a predetermined set of ticket outcomes, each outcome preassigned to a respective digital ticket before distribution, and a game management module configured to maintain a distribution sequence for the digital tickets without altering any preassigned outcome, to assign a next ticket in the distribution sequence responsive to a purchase request, and to log redemptions and awards; and a plurality of client devices, each comprising a display configured to present a digital representation of a paper pull-tab ticket, an input interface configured to receive a user interaction to reveal portions of the ticket, and a communication interface coupled to the central server; wherein, for an authenticated client session and responsive to a purchase request, the central server is configured to assign the next ticket in the distribution sequence and provide render data specifying symbols and any award corresponding to the preassigned outcome of the assigned ticket; and wherein the client device is configured to present reveal interactions that display, the symbols and any award corresponding to the preassigned outcome; and wherein the input interface supports a swipe-to-reveal interaction that peels back virtual tabs, a control input that reveals all remaining concealed regions, and a flip control that displays a back side including a paytable and paylines.

Optionally, the system further includes a security module in the central server, wherein the security module is configured to authenticate each client device connection. The security module ensures the secure transmission of game data and prevents unauthorized access. This enhances the integrity and reliability of the system by safeguarding communication channels between the client devices and the central server.

Optionally, the central server establishes the distribution sequence using a certified shuffler that does not alter any preassigned outcome.

In another embodiment, a system for digitally simulating paper pull-tab games is disclosed. The system includes a central server including at least one processor and memory storing: a predetermined set of game outcomes assigned to respective digital tickets within a deal; a game management module configured to distribute the digital tickets, track redemptions, and log awards; and a security module configured to authenticate client device sessions and enforce encrypted communications; and a plurality of client devices, each comprising a display configured to present a digital pull-tab ticket, an input interface configured to receive a user interaction to reveal portions of the ticket, and a communication interface coupled to the central server; wherein the central server is further configured to: shuffle the predetermined set of game outcomes to establish a distribution sequence without altering the outcomes; in response to a purchase request from an authenticated client device, assign a next ticket in the distribution sequence to the authenticated client device; and provide, to the authenticated client device, render data corresponding to symbols and any award of the assigned ticket, the symbols and award being determined prior to the purchase request and stored at the central server.

In yet another embodiment, a method for digitally simulating paper pull-tab games using a client-server architecture is disclosed. The method includes storing, at a central server, a predetermined set of game outcomes assigned to respective digital tickets within a deal; establishing, by the central server using a certified shuffler, a distribution order for the tickets that does not alter any outcome; authenticating, by a security module of the central server, a client device session and establishing an encrypted communication channel; receiving, from the authenticated client device, a purchase request for a ticket; assigning, by the central server, a next ticket in the distribution order to the authenticated client device; providing, by the central server to the authenticated client device, render data specifying symbols and any award corresponding to the preassigned outcome of the assigned ticket; receiving, at the client device, a user input to reveal a portion of the assigned ticket; and displaying, on the client device, the symbols and any award corresponding to the preassigned outcome, and logging, at the central server, redemption information.

Optionally, and in accordance with any of the above embodiments, the security module may be configured to authenticate a client device session using token-based authentication and to restrict ticket purchase to authenticated sessions over an encrypted transport.

Optionally, and in accordance with any of the above embodiments, the central server may reference a permutation file defining outcomes and pay amounts for the deal, and wherein a paytable presented on the client device scales based on a selected wager according to parameters defined in the permutation file.

Optionally, and in accordance with any of the above embodiments, the input interface may be configured to receive a swipe input that reveals a portion of the ticket and a control input that reveals remaining concealed portions.

Optionally, and in accordance with any of the above embodiments, the central server may log, for each redeemed ticket, at least a ticket identifier, timestamp, client session identifier, and award amount.

Optionally, and in accordance with any of the above embodiments, the communication interface may utilize TCP/IP and the encrypted communications may comprise transport layer encryption.

Optionally, and in accordance with any of the above embodiments, the token-based authentication may comprise issuance and validation of a time-limited token, and the system may be configured to suspend purchasing upon token expiration or loss of the encrypted connection.

Optionally, and in accordance with any of the above embodiments, the game management module may maintain a ticket queue for the deal and, upon exhaustion of the ticket queue, automatically opens a new deal.

Optionally, and in accordance with any of the above embodiments, the permutation file may specify wager-dependent pay amounts for a subset of outcomes and the paytable displayed on the client device updates responsive to a wager change.

Optionally, and in accordance with any of the above embodiments, the client devices may further present a help interface comprising a game information page and a paytable page.

Optionally, and in accordance with any of the above embodiments, the client devices may present a games menu enabling selection among a library of pull-tab simulator titles managed by the central server.

These and other non-limiting aspects and/or objects of the disclosure are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same. Various features are not drawn to scale, and their dimensions may be arbitrarily increased or reduced for clarity of discussion.

FIG. 1 is a system diagram of a paper pull-tab simulator system in accordance with the exemplary embodiments;

FIG. 2 is an illustrative depiction of the front side of a main game screen in accordance with the exemplary embodiments;

FIG. 3 is an illustrative depiction of the back side of a main game screen in accordance with the exemplary embodiments;

FIG. 4 is an example illustration showing a winning game result in accordance with the exemplary embodiments;

FIG. 5 is an illustrative example of the help screen in accordance with the exemplary embodiments;

FIG. 6 is a flowchart illustrating a method for simulating pull-tab games on an electronic device in accordance with the exemplary embodiments;

FIG. 7 is an illustrative depiction of a real-life pull-tab game next to the pull-tab simulator system in accordance with the exemplary embodiments; and

FIG. 8 is a flowchart illustrating a method for simulating pull-tab games on an electronic device in accordance with the exemplary embodiments.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

Spatially relative terms, such as “beneath,” “below,” “lower,” “above,” “upper” and the like, are intended to encompass different orientations of the device in use or operation in addition to the orientation depicted in the figures. The devices may be otherwise oriented (rotated 90 degrees or at other orientations) and the spatially relative descriptors used herein may likewise be interpreted accordingly.

As used herein “pull-tab” refers to a game of chance using a folded or banded paper ticket, or a paper card with perforated break-open tabs, the face of which is covered or otherwise hidden from view to conceal a number, letter, symbol or set of numbers, letters or symbols, some of which have been designated in advance as prize winners and shall include tickets that utilize a seal card. Pull-tabs are commonly referred to as popp-opens tickets, break opens, jar tickets, charity game tickets, and other names.

As used herein, a “simulator game” may be defined as a genre of games that mimics real-world activities, and in this case, the digital pull-tab simulator is a digital representation of a physical pull-tab, mimicking the real-world experience of wagering with a paper pull-tab. The simulator replicates the appearance and gameplay of a traditional pull-tab, including the process of purchasing a card, opening pull-tab windows, discarding losing tickets, and redeeming winning tickets. Furthermore, the gameplay can simulate multiple pull-tab tickets within a deal, from the shuffle of cards and opening a new deal to closing the deal after all tickets have been played.

The pull-tab simulator is a collaborative creation, drawing from various skill sets. First, outcomes are determined by generating a PDF file showing all possible winning and losing combinations, which are printed on physical cards. The game rules are established, including setting the general Return to Player (RTP) allocation. A 3D representation of a 3×3 pull-tab ticket is designed, based on the physical product, while ensuring compliance with digital rules. A series of animations is crafted to replicate the action of opening the pull-tab windows and turning the card over. Meanwhile, the sounds associated with the paper ticket are added, including sound effects like the “rip” of opening a tab. Music to enhance gameplay may be added. The parameters for the game's outcome are designed by using the game rules and the symbol combination file to create a “Perm” file, which assigns outcomes to each ticket in the deal. As used herein, a “Perm” (or permutations) file is a data structure (e.g., JSON) that enumerates tickets in a deal and associates each ticket with a predetermined outcome and any corresponding award values, and it can include parameters for wager-scaled pay amounts.

In one workflow: (i) a paper-game result file (e.g., a PDF exported from a production specification) is obtained; (ii) software evaluates the PDF and copies the enumerated ticket outcomes into a digital data structure; and (iii) a game design mathematician uses the extracted results to generate the Perm used by the digital version to display the correct outcomes. In one embodiment, the “Perm” (permutations) file is a JSON (or equivalent) data structure enumerating each ticket in a deal and associating it with a predetermined outcome. Representative fields can include, for each TicketID: DisplayData (e.g., IsScatterPay; MysteryReveal; WildIndexes; FreeGameIndexes), LineInfo objects (e.g., WinLineNumber; WinDepth; WinningSymbolID; WinAmountInPennies; ConnectedByWild), MainGridSymbolIDs (symbol IDs for the displayed grid), and roll-up values such as BaseSymbolPaysInPennies, BaseFeaturePaysInPennies, SecondaryFeaturePaysInPennies, TotalWinAmountInPennies, LineWinAmountInPennies, and BonusWinAmountInPennies. The schema admits nested arrays for bonus sub-tickets (e.g., FreeGamesInfo) and feature flags (TicketFeatures). It is to be understood that the specific fields and naming above are exemplary and equivalent terminology can be used.

The pull-tab simulator game may be developed using the Unity engine, for example, whereby the game is programmed according to the established game rules. The game references the “Perm” file to deliver the correct outcomes. In terms of gameplay, players start by giving money to the operator, who loads it onto a tablet. The player selects a game from multiple options, and the game loads the backend data, including the “Perm” file. A digital representation of a physical pull-tab ticket is displayed, and the player purchases a ticket by pressing the “Play” button. The game references the outcome from the “Perm” file, determining the symbols displayed, the amount won, and the entertainment features presented to the player. Players reveal each tab by either pressing the open button or manually interacting with the ticket, while the system plays animations and sound effects mimicking the physical card experience. Once all tabs are revealed, the player is shown the final outcome, which mimics the art from the physical card, and the game updates credit meters and win lines. In some embodiments, additional on-screen buttons enable changing a bet amount or ticket value, adjusting sound level, and exiting the game.

Once a deal of tickets has been played, the system automatically opens a new deal without restarting or reloading the game. If the auto-close feature is enabled, a new deal begins once tickets of a certain value are purchased. Players may reload credits or cash out, and upon cashing out, the tablet is returned to the operator, who pays the remaining credit amount to the player.

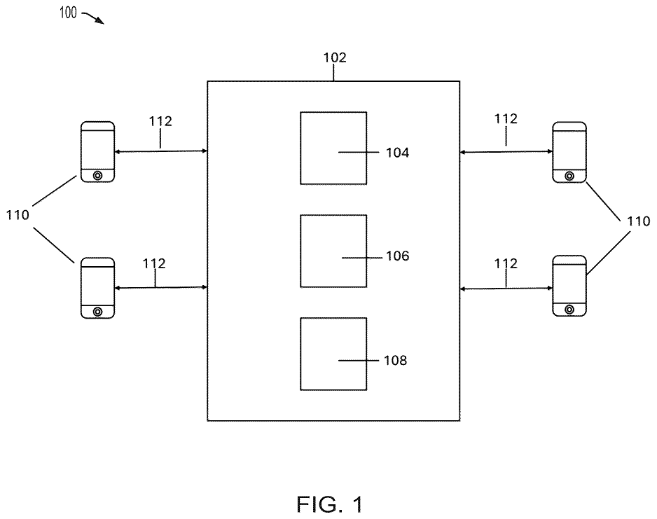

FIG. 1 illustrates an exemplary system diagram for the digital pull-tab system 100 according to the present invention. Although the exemplary system is described in connection with paper pull-tab tickets, it is to be understood that the exemplary system is suitable with any form of paper ticket associated with wagering games. The system includes a central server 102, which is operatively connected to a plurality of client (or user) devices 110. The central server 102 is configured to handle at least three functionalities, an outcome store module 104, a game management module 106, and a security module 108. “Security module” denotes server-side functionality that authenticates client sessions (e.g., via token-based methods) and enforces encrypted transport and can restrict administrative access to outcome data. The bidirectional arrows 112 indicate the secure communication between the central server and the client devices. The outcome store module 104 at least stores a set of predefined game outcomes, while the game management module 106 at least tracks ticket distribution and player interactions. “Predefined game outcome” means an outcome (e.g., symbol arrangement and award) assigned to a specific ticket before distribution; outcomes are not determined at the time of wager. The security module 108 at least ensures that only authenticated client devices can connect to the server. Client-server communications can utilize TCP/IP transport with encrypted channels, and client sessions can be authenticated using token-based credentials (e.g., JSON Web Tokens) issued by the server. An “authentication token” (e.g., a JSON Web Token) is a time-limited credential validated by the server prior to permitting purchases and reveal operations.

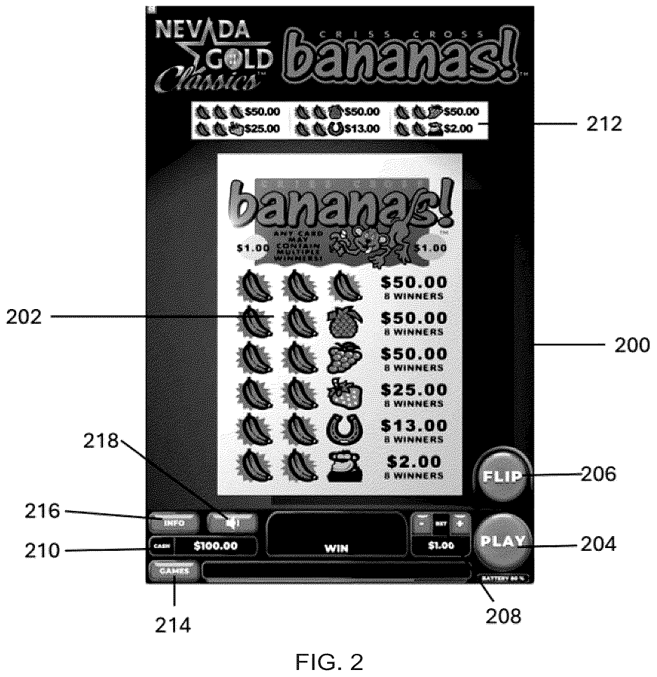

FIG. 2 illustrates the display module 200 on the client device 110, to render data and show what the user sees during interaction with the digital pull-tab game system 100. “Render data” denotes the data provided from the server to a client device specifying the symbols and any award associated with a preassigned ticket outcome for display during reveal interactions. This display is generated and controlled by the game management module 106 within the central server 102, which dynamically creates the visual elements based on the game's state and the user's input. The central server is connected to a plurality of client devices 110, and the game management module 106 is responsible for transmitting the visual content, such as the digital pull-tab tickets, paytables, and game outcomes, to the display module 200 on each client device. Purchasing a ticket generally requires an authenticated session over the encrypted transport, and purchase functionality can be suspended if authentication expires or the secure connection is interrupted. “Purchase request” or “ticket purchase” refers to a client-initiated request that, when authenticated and permitted, causes the server to assign the next ticket in the distribution order to that client device.

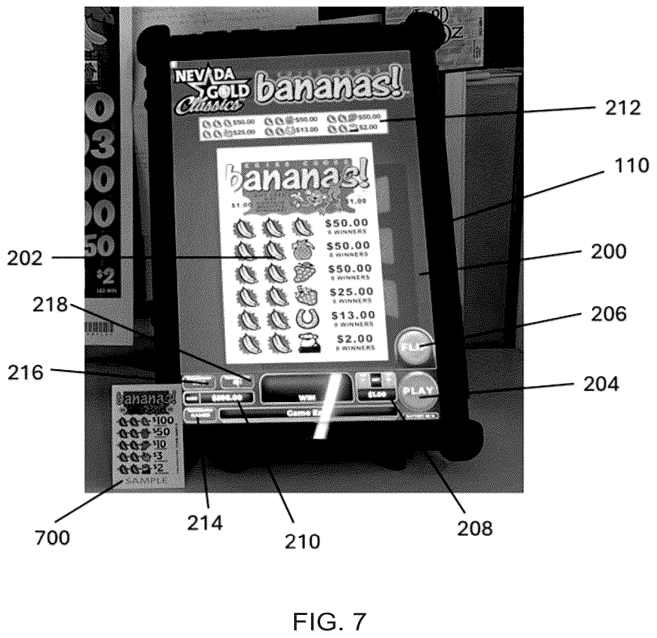

Each client device is configured to present a digital pull-tab ticket 202 to the user through its display module 200, which is updated in real time based on interactions processed by the game management module 106. “Digital ticket” (or “ticket”) refers to a logical unit within a deal to which a predetermined outcome is assigned before distribution and that is revealed via the client interface. For reference, FIG. 7 illustrates an example of a real-life pull-tab card 700 positioned next to the digital pull-tab ticket displayed on the client device. The digital pull-tab ticket 202 is configured to replicate the appearance and player actions of the physical pull-tab card 700, including, but not limited to, opening of tabs, flipping to a paytable/back, and discard/redeem workflows. In addition to the pull-tab ticket, the game management module 106 generates and displays various interactive elements, such as a play button 204 that initiates the tearing away of the pull-tab lines, and a flip button 206 that allows the user to swap between the front and back of the digital pull-tab ticket. The bet amounts 208 are interactable, allowing users to adjust their wager, while the current balance 210 and paytables 212 are displayed as non-interactive elements that provide important game information. Other controls include a games menu button 214 for switching between different available games, an information button 216 for accessing game details, and a volume control 218 for adjusting sound settings. In some embodiments, the games menu 214 may provide, for example, a library of pull-tab simulator titles available at the location, enabling selection among multiple titles. The game management module 106 not only manages the content displayed but also controls how it is presented, ensuring a seamless and engaging user experience. Additionally, the central server 102 generates and securely stores a collection of game outcomes, which are distributed to the client devices 110 upon user interaction. In certain configurations, the client presents swipe-to-reveal interactions for specific touch areas corresponding to ticket regions, and an “Open” control that reveals remaining concealed regions.

In this embodiment the client device 110 includes an input module for receiving user interactions, such as tapping or swiping on the digital pull-tab ticket. The communication module in each client device facilitates secure data transmission between the client device and the central server. Upon receiving a user input, the client device transmits the input data to the central server, where the game management module 106 processes the input, provides the corresponding game outcome from the predefined collection stored in the server's database, and updates the display on the client device accordingly. To enable ticket purchases, some implementations maintain a continuous connection to a site server; upon loss of connectivity or authentication, purchasing is disabled until the session is re-established.

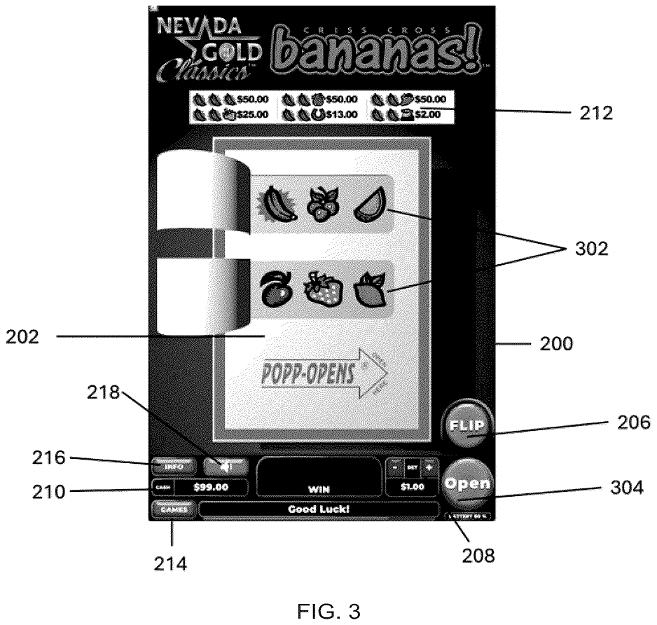

FIG. 3 illustrates the flipped view of the digital pull-tab ticket from FIG. 2, focusing on the paytable and paylines, which are integral components of the digital pull-tab game system 100. The paytable 212 outlines the possible combinations of symbols and their corresponding payouts. Wager-scaled “paytable” refers to a paytable presentation whose displayed award amounts update based on a currently selected wager according to parameters defined, for example, in the Perm file. In some embodiments, a scaling paytable is presented that updates when a player changes the wager; certain outcomes can pay differently at different wager levels, according to parameters defined in the Perm file. Each symbol has a unique value, and specific combinations to trigger different award amounts. The paylines define the paths across the digital ticket 202 where the symbols must align to constitute a win. The central server 102 dynamically updates the paytable 212 and thus the paylines based on the predefined rules of the game, and these updates are communicated to the client devices 110 in real time.

In this flipped view, the user can interact with the digital pull-tab ticket by either tapping or swiping on the virtual tabs to reveal hidden symbols. “Reveal” refers to client-side interactions (e.g., swipe-to-reveal, open-all control) that display, on the client device, symbols corresponding to the preassigned server-side outcome of the assigned ticket. As illustrated in FIG. 3, the paylines define the paths across the digital ticket where the symbols must align to constitute a win. In this example, two of the pull-tab paylines 302 have already been opened, showing the symbols while the remaining tab is still concealed. The user can either (1) press the open button 304 to reveal all remaining hidden symbols at once or (2) manually swipe across the ticket with their finger to peel back the tab individually. Additionally, the user can use the flip button 206 to switch between the front and back of the digital pull-tab ticket, providing a more immersive experience. This interaction simulates the physical act of peeling back tabs on a traditional pull-tab ticket, enhancing user engagement by offering multiple ways to uncover potential winning combinations. In various titles, the user interface (UI) can allow interaction with on-screen symbols or background elements for entertainment effects without changing the predetermined outcome.

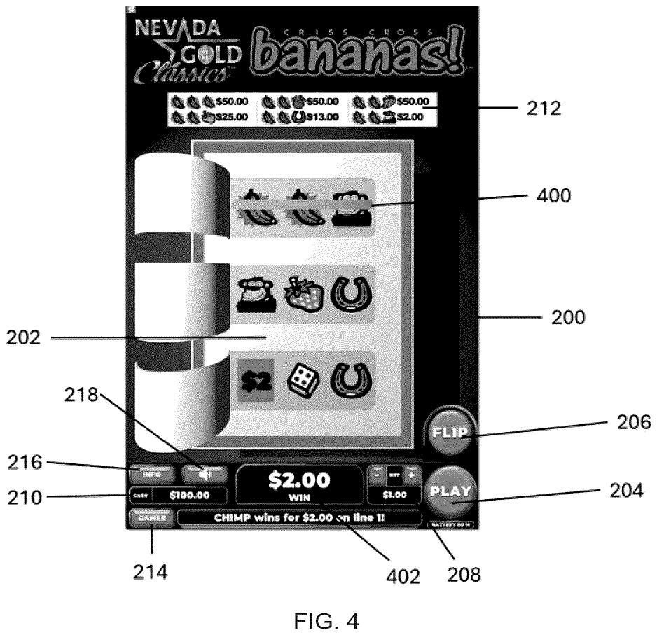

FIG. 4 illustrates an example payout line within the interface 400, which details the specific combination of symbols required to trigger a win, along with the corresponding payout amount 402. This information is dynamically updated based on the game outcomes managed by the central server 102. The payout line display provides administrators with a clear view of active winning combinations and their associated rewards, enabling efficient tracking and validation of game results. Server-side logs can capture, for each redeemed ticket, at least a ticket identifier, timestamp, client session identifier, wager amount, and award amount to facilitate audits and analytics.

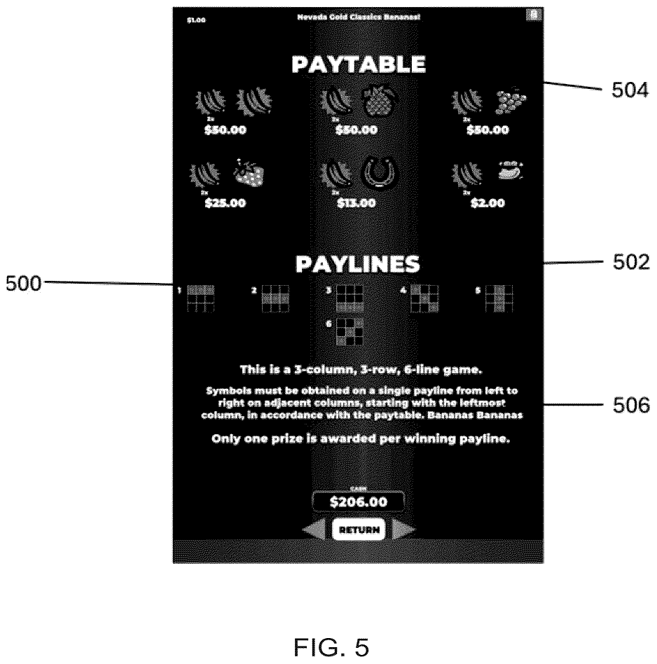

FIG. 5 depicts a help screen 500 that is available on the display module 200 of the client device 110. The help screen provides users with information on how to play the game, including detailed instructions on the gameplay mechanics 502, paytable information 504, and rules 506. This screen is accessible at any time during gameplay, ensuring that players have a clear understanding of how to interact with the digital pull-tab tickets and what to expect in terms of game outcomes and possible winnings. In some embodiments, help pages may be provided, such as “Game Information” and “Paytable.”

In an additional embodiment, the system further includes a security module within the central server. The security module is configured to authenticate each client device connection, ensuring the secure transmission of game data and preventing unauthorized access. This enhances the integrity and reliability of the system by safeguarding communication channels between the client devices and the central server. The authentication process involves verifying device credentials before allowing access to the game outcomes stored in the central server, thereby protecting both the operator and the players. All client-server communications can be encrypted; client sessions can be authenticated using token-based methods (e.g., JWT); and operator access to outcome data can be restricted by administrator passwords and access controls within a secured environment.

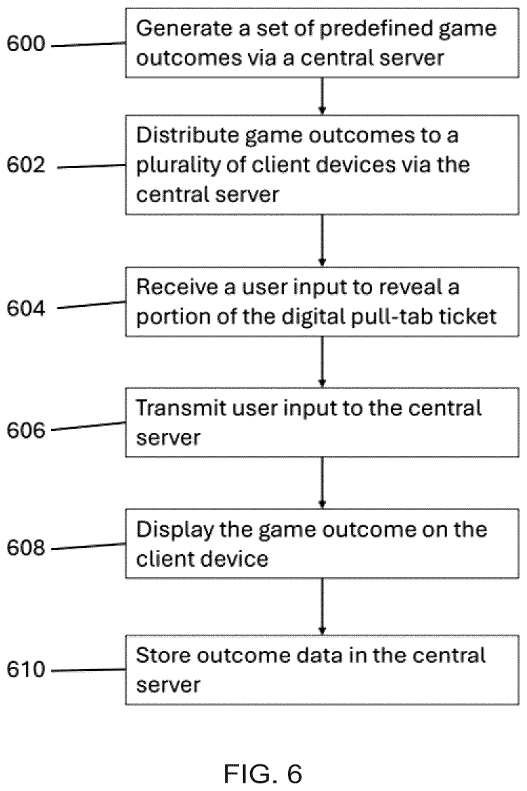

A method for simulating pull-tab games on electronic devices includes several steps, as described in the flowchart of FIG. 6. Although the exemplary method is described in connection with pull-tab tickets, it is to be understood that the exemplary method is suitable with any form of paper ticket associated with wagering games. First, the central server 102 stores a set of predefined game outcomes securely in its database (600). Next, these outcomes are distributed to the client devices 110 (602) upon user interaction (604). The client device 110 then transmits the user input to the central server 102 (606), and the corresponding game outcome is displayed on the client device 110 (608) based on the user's input. The central server 102 then updates its records to reflect the game outcome and any associated awards (610), ensuring accurate tracking and management of all game activities. A certified randomization process can be used to shuffle only the distribution order of tickets within a deal while preserving the predetermined outcomes themselves. “Distribution order” (also referred to as “distribution sequence”) is the order in which tickets from a deal are assigned to client devices; a certified shuffler establishes this order without altering any predetermined outcome.

In an additional embodiment, the method includes providing a secure authentication process for each client device. This step ensures that only authenticated devices can access the game outcomes, enhancing the security and operational efficiency of the system. The authentication process is initiated when a client device 110 attempts to connect to the central server 102, during which the server verifies the device credentials and grants access to the game data only if the device is verified. In some deployments, math-file validation may be performed using an internal validation tool before release, and certain sites may verify outcomes against a printed set of tickets generated from within a machine and cross-checked by a server database.

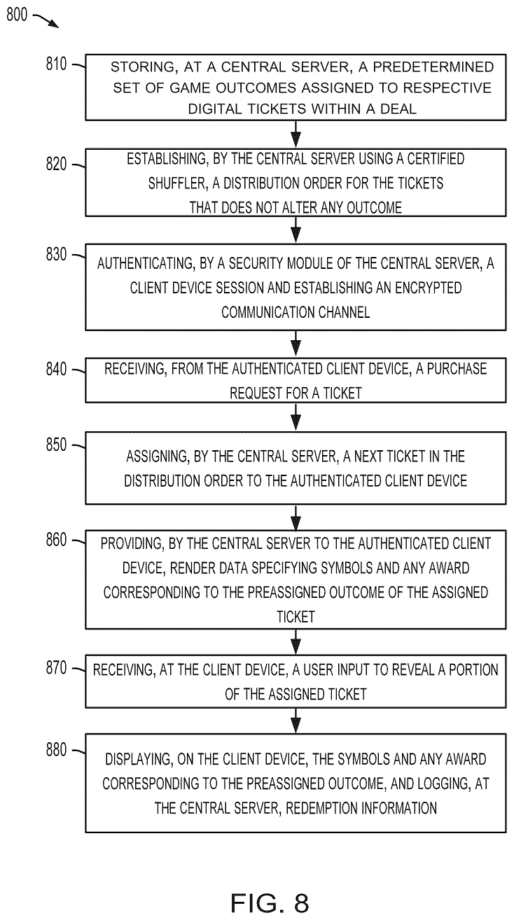

FIG. 8 illustrates a flow diagram of an alternative method 800 for digitally simulating paper pull-tab games using a client-server architecture. Although the steps are shown in a particular order for clarity, certain steps can be performed in parallel, repeated for multiple tickets, or omitted in configurations that do not affect the core functionality.

Initially, the central server 102 stores a predetermined set of game outcomes assigned to respective digital tickets within a deal (810). In one implementation, the central server 102 maintains an outcome store (e.g., a “Perm” file) that enumerates ticket identifiers and the corresponding reveal content (such as symbol grids or other display data) and any associated award values. Each ticket's outcome is preassigned before any player purchase, and the deal record may include metadata such as a deal identifier, total ticket count, paytable data, permissible wager tiers, and integrity information (e.g., checksums) for audit purposes.

The central server 102 establishes a distribution order for the tickets using a certified shuffler that does not alter any preassigned outcome (820). The certified shuffler operates on ticket identifiers only, generating an ordered list or queue that defines the order in which tickets will be dispensed. The server 102 may record a shuffle seed and a cryptographic hash of the ordered list to support later verification, and the distribution order is re-established only upon deal reset or deal exhaustion, without changing any ticket's preassigned outcome.

A security module 108 of the central server 102 authenticates a client device session and establishes an encrypted communication channel (830). Authentication can include credential validation, issuance and validation of a time-limited session token, device or jurisdiction checks, and transport-layer encryption. If authentication or encryption is not in place, the server prevents purchasing activity until the session is compliant.

The server 102 receives, from the authenticated client device 110, a purchase request for a ticket (840). The purchase request can include a game or deal identifier, the selected wager (if applicable), and the session token. The server 102 validates that the deal is active, the distribution order remains unexhausted, the session is authorized for purchasing, and/or any account or credit requirements are satisfied.

The central server 102 assigns a next ticket in the distribution order to the authenticated client device 110 (850). The assignment is performed so as to prevent concurrent sessions from receiving the same ticket. The server 102 associates the assigned ticket identifier with the session, records a timestamp and wager parameters, updates counters indicating remaining tickets, and marks the ticket as dispensed.

The central server 102 provides render data to the authenticated client device 110 for displaying on a display module 200, specifying symbols and any award corresponding to the preassigned outcome of the assigned ticket (860). The render data may include a symbol grid or equivalent reveal content, reveal-sequence metadata identifying which portions are initially concealed, back-side or help views (such as a paytable 212 and paylines), and any wager-dependent presentation values.

The client device 110 receives a user input to reveal a portion of the assigned ticket (870). The input can be, for example, a swipe-to-peel gesture, a tap on an individual concealed region, or activation of a “reveal all” control. Partial reveals update the display incrementally while leaving unrevealed regions concealed until further input, and accessibility options may provide alternative reveal interactions without affecting the outcome.

The client device 110 displays the symbols and any award corresponding to the preassigned outcome, and the central server 102 logs redemption information (880). The logged data can include the ticket identifier, deal identifier, session identifier, timestamps for assignment and redemption, wager amount, award amount, and device or jurisdiction metadata for audit. The server 102 may update balances or credits, issue a redemption record, transition the ticket state to redeemed or closed, and, upon deal exhaustion, either provision a new deal or suspend purchasing until a new deal is available.

Unless stated otherwise, “central server” or “server” encompasses a single server or a cluster; “distribution order” and “distribution sequence” are used interchangeably; and “client device” encompasses tablets and equivalent touch-enabled devices. The architecture can support many concurrent client devices, with practical limits arising from deployment constraints (e.g., site caps). Integration with external digital gaming systems may be restricted without modifying the development-tool architecture.

The exemplary system may thus include one or more computing devices, each of which may be a PC, such as a desktop, a laptop, server computer, microprocessor, cellular telephone, tablet computer, combination thereof, or other computing device capable of executing instructions for performing the exemplary method.

The memory of the computing device(s) may include any type of non-transitory computer readable medium such as random-access memory (RAM), read only memory (ROM), magnetic disk or tape, optical disk, flash memory, or holographic memory. The input/output interfaces may comprise a modulator/demodulator (MODEM) a router, a cable, and/or an Ethernet port. The digital processors of the computing device(s) can be variously embodied, such as by a single-core processor, a dual-core processor (or more generally by a multiple-core processor), a digital processor and cooperating math coprocessor, a digital controller, or the like.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The methods described herein and illustrated in the figures may be at least partially implemented in a computer program product or products that may be executed on one or more computers. The computer program product(s) may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively, the methods may be implemented in transitory media, such as a transmittable carrier wave in which the control program is embodied as a data signal using transmission media, such as acoustic or light waves, such as those generated during radio wave and infrared data communications, and the like.

The exemplary methods may be implemented on one or more general purpose computers, special purpose computers, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like.

As will be appreciated, the steps of the methods need not all proceed in the order illustrated and fewer, more, or different steps may be performed.

The present disclosure has been described with reference to several different embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A system for digitally simulating a paper pull-tab game, comprising:
a central server including at least one processor and memory storing a finite deal comprising a predetermined set of ticket outcomes, each outcome preassigned to a respective digital ticket before distribution, and a game management module configured to maintain a distribution sequence for the digital tickets without altering any preassigned outcome, to assign a next ticket in the distribution sequence responsive to a purchase request, and to log redemptions and awards; and
a plurality of client devices, each comprising a display configured to present a digital representation of a paper pull-tab ticket, an input interface configured to receive a user interaction to reveal portions of the ticket, and a communication interface coupled to the central server;
wherein, for an authenticated client session and responsive to a purchase request, the central server is configured to assign the next ticket in the distribution sequence and provide render data specifying symbols and any award corresponding to the preassigned outcome of the assigned ticket; and
wherein the client device is configured to present reveal interactions that display, the symbols and any award corresponding to the preassigned outcome; and
wherein the input interface supports a swipe-to-reveal interaction that peels back virtual tabs, a reveal-all control that reveals all remaining concealed regions, and a flip control that displays a back side including a paytable and paylines.

2. The system of claim 1, further comprising a security module in the central server, wherein the security module is configured to authenticate each client device connection.

3. The system of claim 1, wherein the central server establishes the distribution sequence using a certified shuffler that does not alter any preassigned outcome.

4. A system for digitally simulating paper pull-tab games, comprising:
a central server including at least one processor and memory storing: a predetermined set of game outcomes assigned to respective digital tickets within a deal; a game management module configured to distribute the digital tickets, track redemptions, and log awards; and a security module configured to authenticate client device sessions and enforce encrypted communications; and
a plurality of client devices, each comprising a display configured to present a digital pull-tab ticket, an input interface configured to receive a user interaction to reveal portions of the ticket, and a communication interface coupled to the central server;
wherein the central server is further configured to:
shuffle the predetermined set of game outcomes to establish a distribution sequence without altering the outcomes;
in response to a purchase request from an authenticated client device, assign a next ticket in the distribution sequence to the authenticated client device; and
provide, to the authenticated client device, render data corresponding to symbols and any award of the assigned ticket, the symbols and award being determined prior to the purchase request and stored at the central server.

5. The system of claim 4, wherein the security module is configured to authenticate a client device session using token-based authentication and to restrict ticket purchase to authenticated sessions over an encrypted transport.

6. The system of claim 4, wherein the central server references a permutation file defining outcomes and pay amounts for the deal, and wherein a paytable presented on the client device scales based on a selected wager according to parameters defined in the permutation file.

7. The system of claim 4, wherein the input interface is configured to receive a swipe input that reveals a portion of the ticket and a control input that reveals remaining concealed portions.

8. The system of claim 4, wherein the central server logs, for each redeemed ticket, at least a ticket identifier, timestamp, client session identifier, and award amount.

9. The system of claim 4, wherein the communication interface utilizes TCP/IP and the encrypted communications comprise transport layer encryption.

10. The system of claim 5, wherein the token-based authentication comprises issuance and validation of a time-limited token, and the system is configured to suspend purchasing upon token expiration or loss of the encrypted connection.

11. The system of claim 4, wherein the game management module maintains a ticket queue for the deal and, upon exhaustion of the ticket queue, automatically opens a new deal.

12. The system of claim 6, wherein the permutation file specifies wager-dependent pay amounts for a subset of outcomes and the paytable displayed on the client device updates responsive to a wager change.

13. The system of claim 4, wherein the client devices further present a help interface comprising a game information page and a paytable page.

14. The system of claim 4, wherein the client devices present a games menu enabling selection among a library of pull-tab simulator titles managed by the central server.

15. A method for digitally simulating paper pull-tab games using a client-server architecture, comprising:
storing, at a central server, a predetermined set of game outcomes assigned to respective digital tickets within a deal;
establishing, by the central server using a certified shuffler, a distribution order for the tickets that does not alter any outcome;
authenticating, by a security module of the central server, a client device session and establishing an encrypted communication channel;
receiving, from the authenticated client device, a purchase request for a ticket;
assigning, by the central server, a next ticket in the distribution order to the authenticated client device;
providing, by the central server to the authenticated client device, render data specifying symbols and any award corresponding to the preassigned outcome of the assigned ticket;
receiving, at the client device, a user input to reveal a portion of the assigned ticket; and
displaying, on the client device, the symbols and any award corresponding to the preassigned outcome, and logging, at the central server, redemption information.

16. The method of claim 15, further comprising presenting, on the client device, a paytable that scales based on a selected wager according to parameters defined in a server-referenced permutation file.

17. The method of claim 15, wherein purchasing and revealing are permitted only during an authenticated session over an encrypted transport.

18. The method of claim 15, further comprising preventing outcome generation at the client device and restricting outcome determination to the predetermined set stored at the central server.

19. The method of claim 15, further comprising generating the permutation file by parsing a paper-game specification to derive ticket outcomes and award values and enumerating ticket identifiers and outcomes for the deal.

20. The method of claim 15, further comprising server-side logging of, for each redeemed ticket, at least a ticket identifier, timestamp, session identifier, wager amount, and award amount.
